(19) United States
(12) Patent Application Publication
(10) Pub. No.: US 2026/0106542 A1
(43) Pub. Date: Apr. 16, 2026

(54) MULTI-PHASE LLC RESONANT CONVERTER

(71) Applicant: Lite-On Technology Corporation, Taipei (TW)

(72) Inventors: Bo Ruei Ciou, Taipei (TW); Chen Chen, Taipei (TW)

(73) Assignee: Lite-On Technology Corporation, Taipei (TW)

(21) Appl. No.: 19/093,150

(22) Filed: Mar. 27, 2025

Related U.S. Application Data
(60) Provisional application No. 63/707,202, filed on Oct. 15, 2024.

(30) Foreign Application Priority Data
Jan. 22, 2025 (CN) 202520151277.8

(51) Int. Cl. H02M 3/00; H02M 3/335

(52) U.S. Cl. CPC H02M 3/01; H02M 3/33576

(57) ABSTRACT

A multi-phase LLC resonant converter including a resonant tank, a switch circuit, and a rectifier circuit is provided. The resonant tank includes a resonant circuit and a transformer. The resonant circuit includes a plurality of resonant inductors, and the resonant inductors are connected in a delta connection. The switch circuit is disposed on a primary side of the transformer and has a half-bridge structure. The rectifier circuit is disposed on a secondary side of the transformer and has a full-bridge structure.

### CROSS-REFERENCE TO RELATED APPLICATION

This application claims the priority benefit of U.S. provisional application Ser. No. 63/707,202, filed on Oct. 15, 2024 and China application serial no. 202520151277.8, filed on Jan. 22, 2025. The entirety of each of the above-mentioned patent applications is hereby incorporated by reference herein and made a part of this specification.

### BACKGROUND

### Technical Field

The disclosure relates to a resonant converter, and particularly to a multi-phase LLC resonant converter.

### Description of Related Art

The commonly used multi-phase LLC resonant converter architectures include half-bridge and full-bridge configurations. In applications involving low voltage and high current, the half-bridge configuration tends to have a higher proportion of coil losses on both primary and secondary sides of a transformer, while the full-bridge configuration exhibits a larger proportion of magnetic core losses in the transformer. Therefore, finding a balance between coil losses and magnetic core losses is an important issue in this technical field. Besides, the existing multi-phase LLC resonant converter architectures may not effectively reduce the magnetic core losses, and when there are discrepancies in passive elements, achieving balanced current cannot be possible.

### SUMMARY

The disclosure provides a multi-phase LLC resonant converter that can reduce magnetic core losses and has good current balancing capability.

According to an embodiment of the disclosure, a multi-phase LLC resonant converter includes a resonant tank, a switch circuit, and a rectifier circuit. The resonant tank includes a resonant circuit and a transformer. The resonant circuit includes a plurality of resonant inductors, and the resonant inductors are connected in a delta connection. The switch circuit is disposed on a primary side of the transformer and has a half-bridge structure. The rectifier circuit is disposed on a secondary side of the transformer and has a full-bridge structure.

To make the above features and advantages of the disclosure more apparent and understandable, embodiments are described below with reference to the accompanying drawings in detail as follows.

### BRIEF DESCRIPTION OF THE DRAWINGS

FIG. 1 is a schematic block diagram of a multi-phase LLC resonant converter according to an embodiment of the disclosure.

FIG. 2 is a schematic diagram of a circuit structure of a multi-phase LLC resonant converter according to an embodiment of the disclosure.

FIG. 3 is a schematic diagram of waveforms of various currents in the multi-phase LLC resonant converter according to the embodiment of the disclosure depicted in FIG. 2.

FIG. 4 is a schematic diagram of the circuit structure of another embodiment of the multi-phase LLC resonant converter according to the disclosure.

FIG. 5 is a schematic diagram of a structure of a switch circuit according to an embodiment of the disclosure.

FIG. 6 is a schematic diagram of waveforms of the gate source voltage signal according to the embodiment of the disclosure depicted in FIG. 5.

FIG. 7 is a schematic diagram of waveforms of the first voltage signal and the fourth voltage signal according to the embodiment of the disclosure depicted in FIG. 5.

FIG. 8 is a schematic diagram of waveforms of the drain source voltage signal and the excitation current according to the embodiment of the disclosure depicted in FIG. 5.

FIG. 9 is a schematic diagram of a structure of a rectifier circuit according to an embodiment of the disclosure.

FIG. 10 is a schematic diagram of waveforms of the drain source voltage signal according to the embodiment of the disclosure depicted in FIG. 9.

FIG. 11A is a schematic three-dimensional diagram of a magnetic core structure of a resonant inductor and a magnetic core structure of a transformer according to an embodiment of the disclosure.

FIG. 11B is a schematic three-dimensional diagram of the magnetic core structure and its coils according to the embodiment of the disclosure depicted in FIG. 11A.

FIG. 12A is a schematic side view of the magnetic core structure according to the embodiment of the disclosure depicted in FIG. 11A.

FIG. 12B is a schematic side view of the magnetic core structure and its coils according to the embodiment of the disclosure depicted in FIG. 11B.

FIG. 13 is a schematic diagram of the winding of the primary side coils and the secondary side coils of the transformer according to the embodiment of the disclosure depicted in FIG. 11B and FIG. 12B.

FIG. 14 is a schematic diagram of a structure with an air gap existing in core columns of the resonant inductor and the transformer according to the embodiment of the disclosure depicted in FIG. 11A and FIG. 12A.

### DESCRIPTION OF THE EMBODIMENTS

The following embodiments are presented to illustrate the disclosure and are not intended to limit the scope provided in the disclosure, and the provided embodiments can be appropriately combined. It is understood that the embodiments may be modified and combined as appropriate without departing from the spirit and scope of the disclosure. The terminology “couple (or connect)” used throughout the whole description of the disclosure (including the claims) may refer to any direct or indirect connection means. For instance, if the disclosure describes that a first device is coupled (or connected) to a second device, it should be interpreted that the first device may be directly connected to the second device, or that the first device may be indirectly connected to the second device through other devices or certain connection means. In addition, the terminology “signal” as used herein encompasses a variety of forms, including but not limited to current, voltage, charge, temperature, data, electromagnetic waves, or any combination thereof.

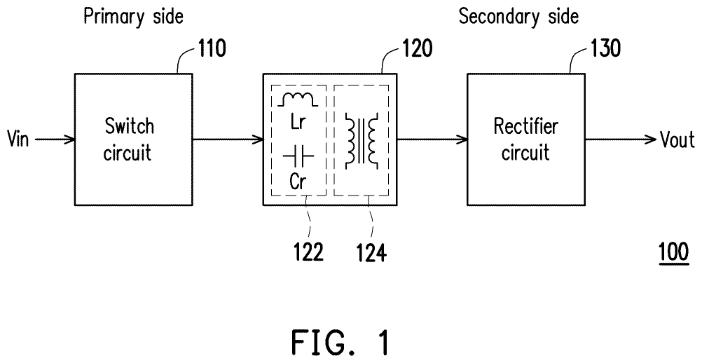

FIG. 1 is a schematic block diagram of a multi-phase LLC resonant converter according to an embodiment of the disclosure. With reference to FIG. 1, a multi-phase LLC resonant converter 100 includes a switch circuit 110, a resonant tank 120, and a rectifier circuit 130. The resonant tank 120 includes a resonant circuit 122 and a transformer 124. The switch circuit 110 is disposed on a primary side of the transformer 124, and the rectifier circuit 130 is disposed on a secondary side of the transformer 124. The switch circuit 110 has a half-bridge structure, and the rectifier circuit 130 has a full-bridge structure.

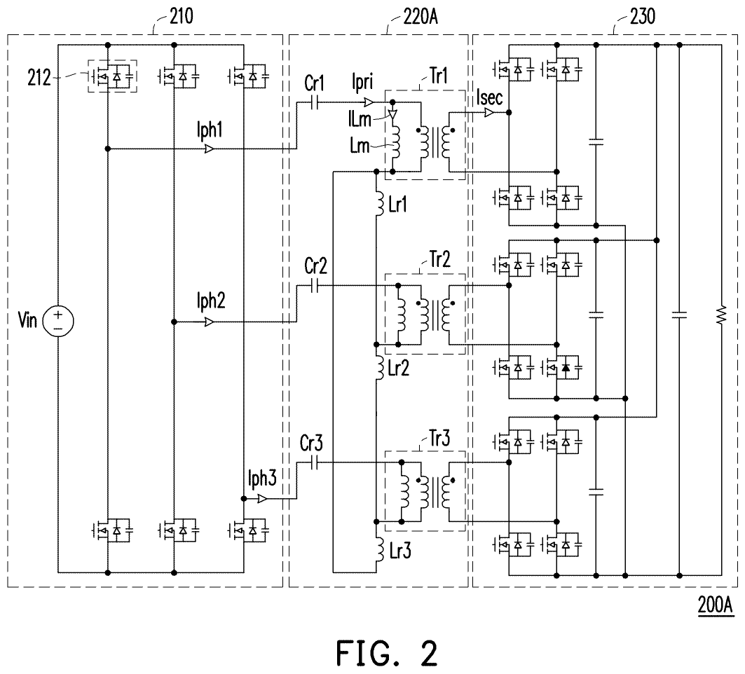

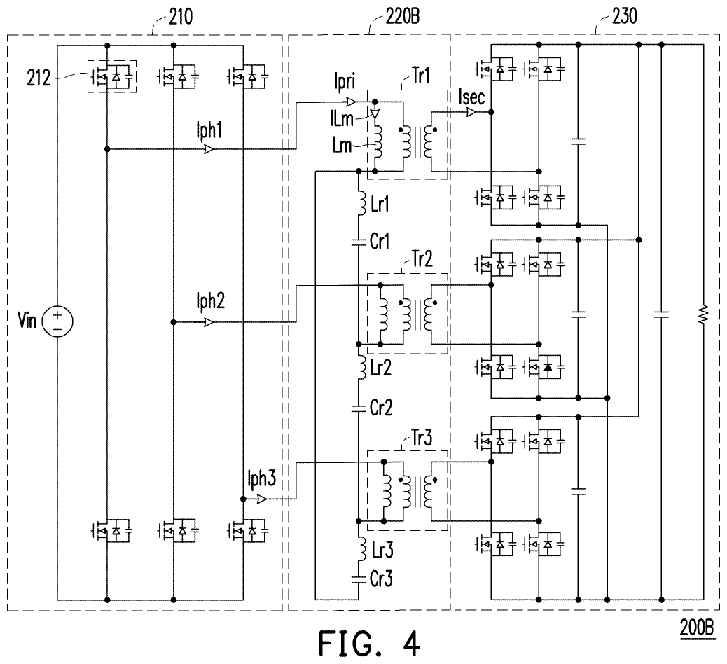

The resonant circuit 122 includes a plurality of resonant inductors Lr and a plurality of resonant capacitors Cr. In one embodiment of the disclosure (FIG. 2), the resonant inductors Lr are connected in a delta connection. In another embodiment (FIG. 4), the resonant inductors Lr and the resonant capacitors Cr are connected in a delta connection.

In this embodiment, the multi-phase LLC resonant converter 100 is, for instance, a three-phase LLC resonant converter, serves as a DC/DC power converter, and is configured to convert a direct current input voltage Vin to a direct current output voltage Vout.

The multi-phase LLC resonant converter 100 can at least be applied to circuit structures of charging piles, energy storage systems, and artificial intelligence servers. The application scope of the multi-phase LLC resonant converter 100 is not limited in the disclosure.

In this embodiment, since the switch circuit 110 has the half-bridge structure and the rectifier circuit 130 has the full-bridge structure, in low voltage and high current applications, the multi-phase LLC resonant converter 100 can solve the problem of higher coil losses in the primary side and secondary side coils of the transformer in a half-bridge configuration and also solve the problem of higher magnetic core losses in the transformer in a full-bridge configuration. Thus, a balance between the coil losses and the magnetic core losses can be achieved.

Moreover, in this embodiment, by connecting the resonant inductors Lr in a delta connection or by connecting both the resonant inductors Lr and the resonant capacitors Cr in a delta connection in conjunction with the half-bridge full-bridge configuration, the multi-phase LLC resonant converter 100 not only reduces the magnetic core losses but also maintains good current balancing capability when passive elements (such as the resonant inductors Lr or the resonant capacitors Cr) exhibit errors.

Various different implementations of the circuit structure of the multi-phase LLC resonant converter are described below. However, it should be understood that the disclosure is not limited to the provided embodiments.

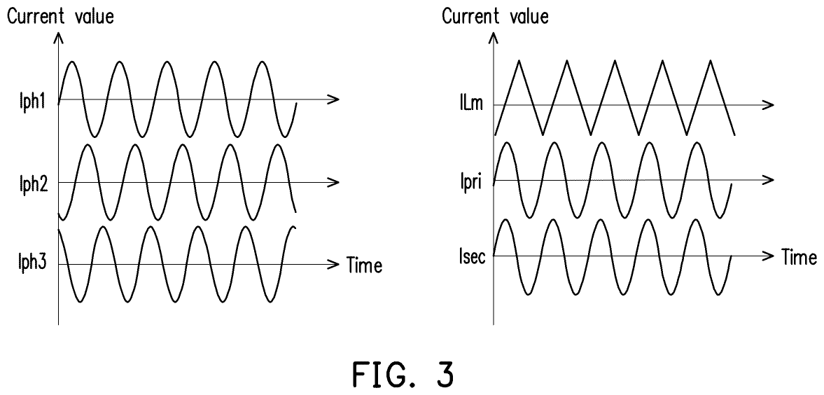

FIG. 2 is a schematic diagram of a circuit structure of a multi-phase LLC resonant converter according to an embodiment of the disclosure. FIG. 3 is a schematic diagram of waveforms of various currents in the multi-phase LLC resonant converter according to the embodiment of the disclosure depicted in FIG. 2. With reference to FIG. 2 and FIG. 3, a multi-phase LLC resonant converter 200A includes a switch circuit 210, a resonant tank 220A, and a rectifier circuit 230. The resonant tank 220A includes a resonant circuit and transformers Tr1 to Tr3. The resonant circuit includes a plurality of resonant inductors Lr1 to Lr3 and a plurality of resonant capacitors Cr1 to Cr3. The resonant inductors Lr1 to Lr3 are connected in a delta connection.

The switch circuit 210 includes a plurality of switch elements 212 connected in a star connection. Each switch element 212 can be a metal-oxide-semiconductor transistor and can have a parasitic diode and a parasitic capacitor. The switch circuit 210 serves as a power switch and has a half-bridge configuration for generating a square wave with an offset of Vin/2 and outputting three-phase currents Iph1 to Iph3 as shown in FIG. 3. Additionally, in FIG. 3, ILm is an excitation current of an excitation inductor Lm, Ipri is a primary side current of the transformer Tr1, and Isec is a secondary side current of the transformer Tr1.

FIG. 4 is a schematic diagram of the circuit structure of another embodiment of the multi-phase LLC resonant converter according to the disclosure. With reference to FIG. 2 and FIG. 4, the circuit structure of the multi-phase LLC resonant converter 200B in FIG. 4 is similar to that of the multi-phase LLC resonant converter 200A in FIG. 2, whereas in the embodiment depicted in FIG. 4, the resonant capacitors Cr1 to Cr3 and the resonant inductors Lr1 to Lr3 are connected in a delta connection. Moreover, waveforms of currents in the multi-phase LLC resonant converter 200B are also similar to those depicted in FIG. 3.

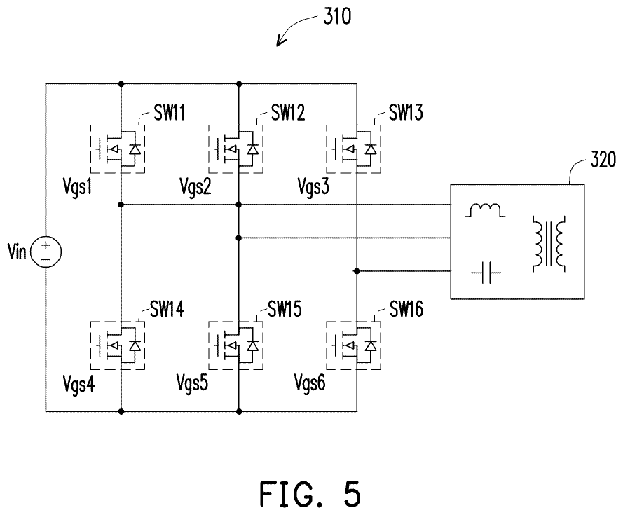

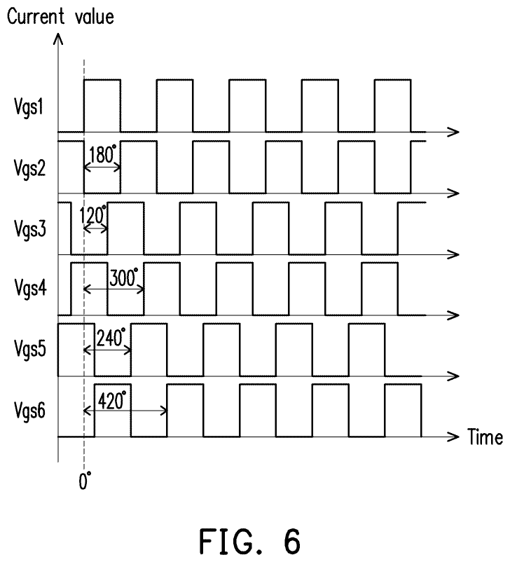

The primary side switch control is explained below. FIG. 5 is a schematic diagram of a structure of a switch circuit according to an embodiment of the disclosure. FIG. 6 is a schematic diagram of waveforms of the gate source voltage signal according to the embodiment of the disclosure depicted in FIG. 5. With reference to FIG. 5 and FIG. 6, a switch circuit 310 has a half-bridge structure and is disposed on a primary side of a resonant tank 320. The switch circuit 310 includes a plurality of switch elements SW11 to SW16. The switch elements SW11 to SW16 are connected in a star connection. Each switch element SW11 to SW16 can be a metal-oxide-semiconductor transistor and has a parasitic diode and a parasitic capacitor.

The gate source voltage signals Vgs1 to Vgs6 of the switch elements SW11 to SW16 are complementary in pairs. For instance, a phase difference between the first voltage signal Vgs1 and the fourth voltage signal Vgs4 is 180 degrees, a phase difference between the second voltage signal Vgs2 and the fifth voltage signal Vgs5 is 180 degrees, and a phase difference between the third voltage signal Vgs3 and the sixth voltage signal Vgs6 is 180 degrees, indicating that the gate source voltage signals Vgs1 to Vgs6 are complementary in pairs.

Moreover, phase differences among the first voltage signal Vgs1, the second voltage signal Vgs2, and the third voltage signal Vgs3 are 120 degrees, respectively, and phase differences among the fourth voltage signal Vgs4, the fifth voltage signal Vgs5, and the sixth voltage signal Vgs6 are also 120 degrees, respectively.

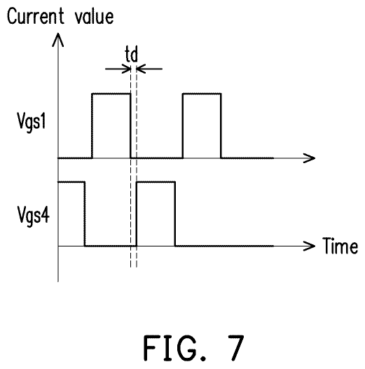

In this embodiment, dead time td exists between the complementary gate source voltage signals, as shown in FIG. 7, so as to prevent the switch elements SW11 and SW14, the switch elements SW12 and SW15, or the switch elements SW13 and SW16 from being turned on simultaneously. FIG. 7 is a schematic diagram of waveforms of the first voltage signal Vgs1 and the fourth voltage signal Vgs4 according to the embodiment of the disclosure depicted in FIG. 5. With reference to FIG. 7, FIG. 7 shows that the dead time td exists between the complementary gate source voltage signals Vgs1 and Vgs4 to prevent the switch elements SW11 and SW14 from being turned on simultaneously.

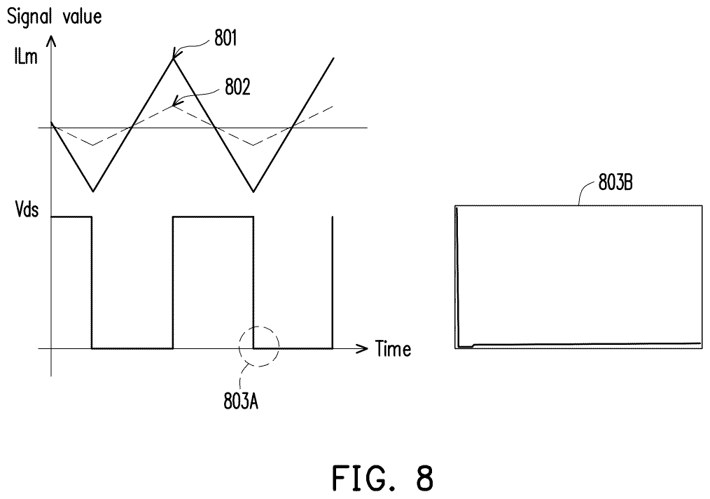

FIG. 8 is a schematic diagram of waveforms of the drain source voltage signal Vds and the excitation current ILm according to the embodiment of the disclosure depicted in FIG. 5, where Vds is a drain source voltage signal of the switch elements SW11 to SW16. With reference to FIG. 7 and FIG. 8, in this embodiment, the magnitude of the dead time td depends on parasitic capacitance values of the switch elements on the primary and secondary sides and an excitation inductance value of the transformer.

For instance, in FIG. 8, a signal waveform 801 shows the variations in the current of the excitation inductor ILm with a relatively small excitation inductance value, while a signal waveform 802 shows the variations in the current of the excitation inductor ILm with a relatively large excitation inductance value.

When the excitation inductance value is relatively small, the drain source voltage signal Vds of the switch elements SW11 to SW16 on the primary side can quickly discharge to 0 volt, as shown by a signal waveform 803B. Therefore, the dead time td is relatively short. Here, the signal waveform 803B is a schematic enlarged diagram of a signal waveform 803A when the excitation inductance value is relatively small. The signal waveform 803B indicates that the switch elements SW11 to SW16 have zero voltage switching capability.

On the other hand, when the excitation inductance value is relatively large, a longer dead time td is needed to discharge the drain source voltage signal Vds to 0 volt, as shown by the signal waveform 803B. Therefore, corresponding to the relatively large excitation inductance value, the dead time td is also set to be relatively long, which allows the switch elements SW11 to SW16 to have zero voltage switching capability as well.

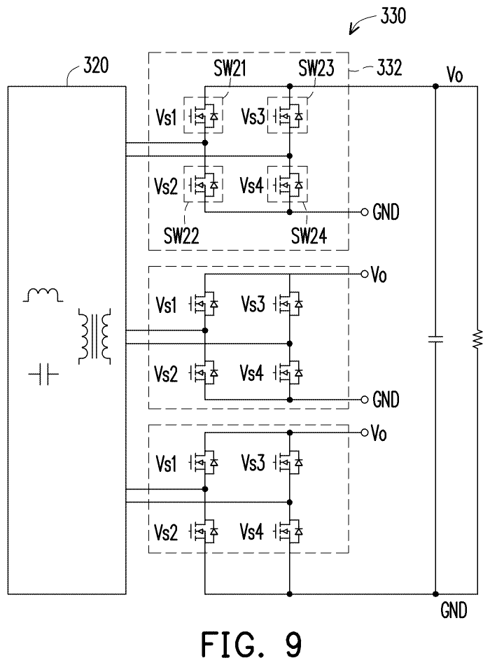

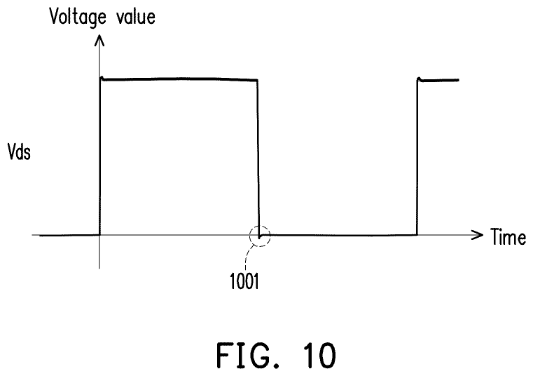

The switch control on the secondary side is explained below. FIG. 9 is a schematic diagram of a structure of a rectifier circuit according to an embodiment of the disclosure. FIG. 10 is a schematic diagram of waveforms of the drain source voltage signal according to the embodiment of the disclosure depicted in FIG. 9. With reference to FIG. 9 and FIG. 10, a rectifier circuit 330 has a full-bridge configuration and is disposed on the secondary side of the resonant tank 320. The rectifier circuit 310 includes a plurality of switch element groups 332. Each switch element group 332 is coupled between a first voltage Vo and a second voltage GND and is controlled by a plurality of control signals Vs1 to Vs4. Here, the first voltage Vo is, for instance, a direct current output power supply voltage Vout of the multi-phase LLC resonant converter 100, and the second voltage GND is, for instance, a ground voltage, which should not be construed as limitations in the disclosure.

Each switch element group 332 includes switch elements SW21 to SW24. Each switch element SW21 to SW24 can be a metal-oxide-semiconductor transistor and has a parasitic diode and a parasitic capacitor. The switch elements SW21 to SW24 are controlled by the control signals Vs1 to Vs4, respectively. Drivers (not shown) configured to control the switch elements SW21 to SW24 can output the control signals Vs1 to Vs4 based on the drain source voltage signal Vds to determine whether to turn on the switch elements SW21 to SW24.

For instance, when a voltage of the drain source voltage signal Vds drops below 0 volt, as shown by a signal waveform 1001, the drivers may detect a negative voltage. At this time, the drivers output the control signals Vs1 to Vs4 to turn on the switch elements SW21 to SW24. In other words, when the drain source voltage signal Vds of the switch elements SW21 to SW24 in the switch element group 332 is less than a reference voltage, the control signals Vs1 to Vs4 control the switch elements SW21 to SW24 in the switch element group 332 to turn on. In this embodiment, the reference voltage is set to 0 volt, which should however not be construed as a limitation in the disclosure.

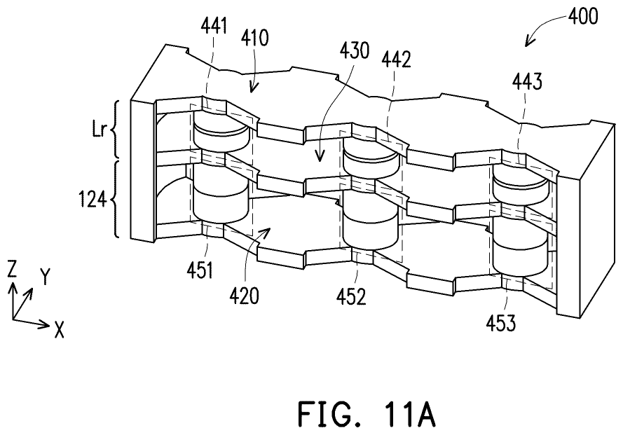

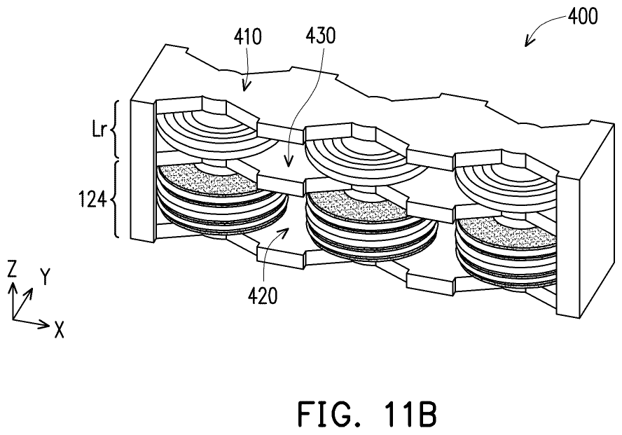

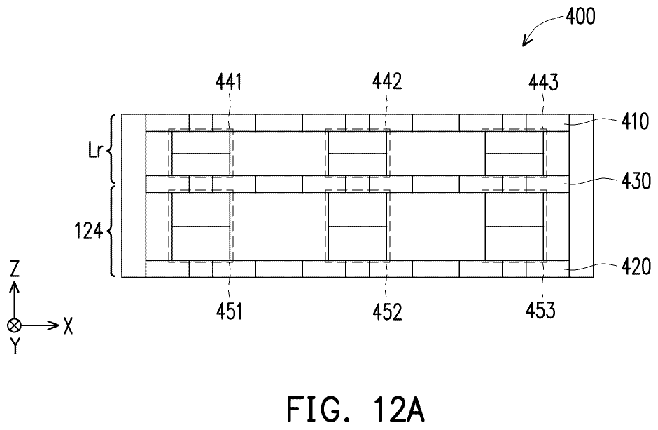

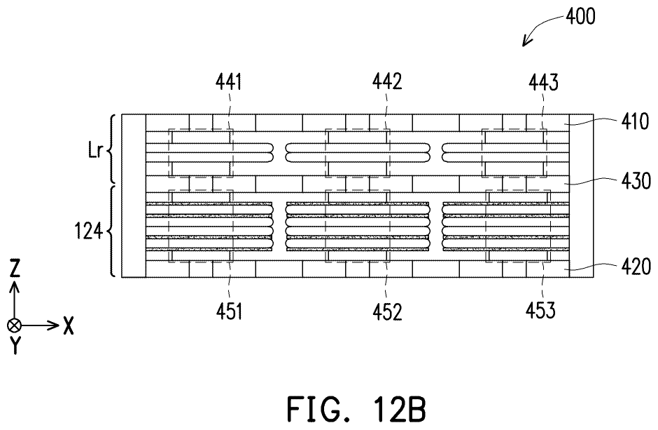

A magnetic core structure of the resonant inductor and a magnetic core structure of the transformer are explained below. FIG. 11A is a schematic three-dimensional diagram of a magnetic core structure of a resonant inductor and a magnetic core structure of a transformer according to an embodiment of the disclosure. FIG. 11B is a schematic three-dimensional diagram of the magnetic core structure and its coils according to the embodiment of the disclosure depicted in FIG. 11A. FIG. 12A is a schematic side view of the magnetic core structure according to the embodiment of the disclosure depicted in FIG. 11A. FIG. 12B is a schematic side view of the magnetic core structure and its coils according to the embodiment of the disclosure depicted in FIG. 11B.

With reference to FIG. 11A to FIG. 12B, the resonant inductor Lr and the transformer 124 in FIG. 1 are taken as an example, and the magnetic core of the resonant inductor Lr and the magnetic core of the transformer 124 are integrated to form an integrated magnetic core structure 400. The integrated magnetic core structure 400 includes a first cover plate 410, a second cover plate 420, and an intermediate laminated board 430. A first core column 441, a second core column 442, and a third core column 443 of the resonant inductor Lr are located between the first cover plate 410 and the intermediate laminated board 430 and are not coupled to one another. A first core column 451, a second core column 452, and a third core column 453 of the transformer 124 are located between the intermediate laminated board 430 and the second cover plate 420 and are not coupled to one another. The core columns 441, 442, and 443 of the resonant inductor Lr and the core columns 451, 452, and 453 of the transformer 124 are also not coupled to one another.

In this embodiment, a lower cover of the first core column 441, the second core column 442, and the third core column 443 of the resonant inductor Lr constitutes the intermediate laminated board 430, and an upper cover of the first core column 451, the second core column 452, and the third core column 453 of the transformer 124 constitutes the intermediate laminated board 430. In other words, the lower cover of the resonant inductor Lr and the upper cover of the transformer 124 are both the same intermediate laminated board 430 and thus are integrated together to form the integrated magnetic core structure 400. Compared to a non-integrated magnetic core structure, where the lower cover of the resonant inductor and the upper cover of the transformer are two different covers, the integrated magnetic core structure 400 not only can reduce the volume of the resonant inductor Lr and transformer 124 but also can reduce the loss of magnetic elements.

On the other hand, coils on the first core column 441, the second core column 442, and the third core column 443 of the resonant inductor Lr are wound in the same direction, e.g., all in a clockwise direction or a counterclockwise direction. Primary side coils and secondary side coils on the first core column 451, the second core column 452, and the third core column 453 of the transformer 124 are wound in the same direction. Moreover, the coils of the resonant inductor Lr and the primary side coils and the secondary side coils of the transformer 124 are also wound in the same direction.

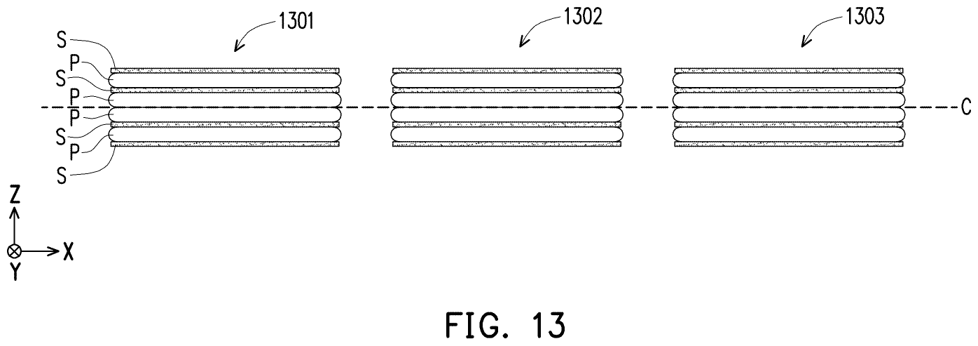

FIG. 13 is a schematic diagram of the winding of the primary side coils and the secondary side coils of the transformer according to the embodiment of the disclosure depicted in FIG. 11B and FIG. 12B, where coil groups 1301, 1302, and 1303 of the transformer 124 are the primary side coils P and the secondary side coils S on the first core column 451, the second core column 452, and the third core column 453, respectively. With reference to FIG. 13, the primary side coils on the first core column 451, the second core column 452, and the third core column 453 of the transformer 124 are marked as P, and the secondary side coils are marked as S. The primary side coils P and the secondary side coils S are wound symmetrically with respect to a reference axis C. Moreover, the primary side coils P and the secondary side coils S are wound in an interleaved manner on upper and lower sides of the reference axis C.

In a three-phase configuration, the circuit may easily experience uneven current magnitudes in each phase due to inconsistencies in the size of stray elements on the circuit. To address this issue, the transformer coils utilize a symmetrical winding method as shown in FIG. 13, with the primary side coils P and the secondary side coils S arranged in an interleaved manner. This configuration helps minimize losses associated with alternating current resistance.

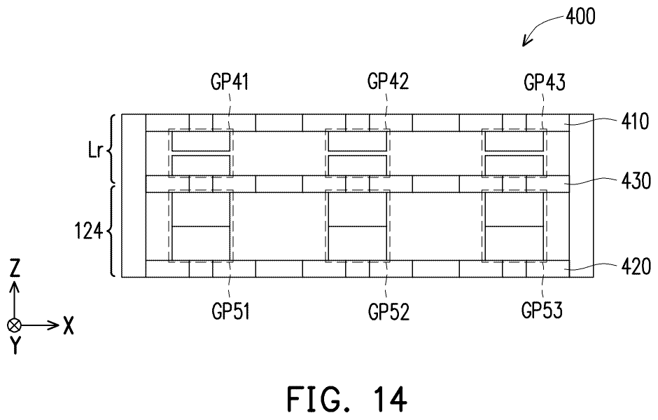

FIG. 14 is a schematic diagram of a structure with an air gap existing in core columns of the resonant inductor and the transformer according to the embodiment of the disclosure depicted in FIG. 11A and FIG. 12A. With reference to FIG. 14, air gaps GP41, GP42, and GP43 exist in middle portions of the first core column 441, the second core column 442, and the third core column 443 of the resonant inductor Lr, respectively; air gaps GP51, GP52, and GP53 exist in middle portions of the first core column 451, the second core column 452, and the third core column 453 of the transformer 124, respectively. The positions of the aforementioned air gaps are not intended to limit the disclosure.

In this embodiment, since a magnetic flux path generated by the second core column 442 of the resonant inductor Lr is longer, in order to ensure the consistency in the inductance on each core column, the width of the air gap GP42 of the second core column 442 can be designed to be smaller than the width of the air gap GP41 of the first core column 441 and the width of the air gap GP43 of the third core column 443. Additionally, the width of the air gap GP41 of the first core column 441 and the width of the air gap GP43 of the third core column 443 can be designed to be equal, i.e., GP42<GP43=GP41. The relationship between the air gap sizes of each core column in the transformer 124 can also be designed in a similar manner, i.e., GP52<GP53=GP51.

Moreover, in this embodiment, since the air gaps are located in the middle portions of their respective core columns, Litz wire coils can serve the coils near the peripheries of the air gaps to reduce the alternating current loss brought to the coils by the air gaps.

On the other hand, in this embodiment, since the effective cross-sectional area of a central column of the resonant inductor Lr is the same as the effective cross-sectional area of a central column of the transformer 124, and the inductance of the resonant inductor Lr is smaller than the inductance of the transformer 124, the air gaps GP41, GP42, and GP43 of the first core column 441, the second core column 442, and the third core column 443 of the resonant inductor Lr can be designed to be larger than the air gaps GP51, GP52, and GP53 of the first core column 451, the second core column 452, and the third core column 453 of the transformer 124.

To sum up, in one or more embodiments of the disclosure, since the switch circuit has the half-bridge structure and the rectifier circuit has the full-bridge structure, in low voltage and high current applications, the multi-phase LLC resonant converter can solve the problem of higher coil losses in the primary and secondary side coils of the transformer in the half-bridge configuration and also solve the problem of higher magnetic core losses in the transformer in the full-bridge configuration, thereby achieving a balance between the coil losses and the magnetic core losses. Besides, the resonant inductors and the resonant capacitors are connected in a delta connection, which, in conjunction with the half-bridge full-bridge configuration, not only can reduce the magnetic core losses but also provide the multi-phase LLC resonant converter with good current balancing capability when the passive elements exhibit errors.

Although the disclosure has been disclosed in the embodiments as above, it is not intended to limit the disclosure. Any person skilled in the art may make some modifications and refinements without departing from the spirit and scope of the disclosure. Therefore, the protection scope of the disclosure should be defined by the appended claims.

What is claimed is:

1. A multi-phase LLC resonant converter, comprising:
a resonant tank, comprising a resonant circuit and a transformer, wherein the resonant circuit comprises a plurality of resonant inductors, and the resonant inductors are connected in a delta connection;
a switch circuit, disposed on a primary side of the transformer and having a half-bridge structure; and
a rectifier circuit, disposed on a secondary side of the transformer and having a full-bridge structure.

2. The multi-phase LLC resonant converter according to claim 1, wherein the resonant circuit further comprises a plurality of resonant capacitors, and the resonant inductors and the resonant capacitors are connected in a delta connection.

3. The multi-phase LLC resonant converter according to claim 1, wherein the switch circuit comprises a plurality of switch elements, and gate source voltage signals of the switch elements are complementary in pairs.

4. The multi-phase LLC resonant converter according to claim 3, wherein dead time exists between the complementary gate source voltage signals.

5. The multi-phase LLC resonant converter according to claim 4, wherein a magnitude of the dead time depends on parasitic capacitance values of the switch elements on the primary side and the secondary side and an excitation inductance value of the transformer.

6. The multi-phase LLC resonant converter according to claim 3, wherein the gate source voltage signals comprise a first voltage signal, a second voltage signal, a third voltage signal, a fourth voltage signal, a fifth voltage signal, and a sixth voltage signal, wherein a phase difference between the first voltage signal and the fourth voltage signal is 180 degrees, a phase difference between the second voltage signal and the fifth voltage signal is 180 degrees, and a phase difference between the third voltage signal and the sixth voltage signal is 180 degrees.

7. The multi-phase LLC resonant converter according to claim 6, wherein phase differences among the first voltage signal, the second voltage signal, and the third voltage signal are respectively 120 degrees, and phase differences among the fourth voltage signal, the fifth voltage signal, and the sixth voltage signal are respectively 120 degrees.

8. The multi-phase LLC resonant converter according to claim 3, wherein the switch elements are connected in a star connection.

9. The multi-phase LLC resonant converter according to claim 1, wherein the rectifier circuit comprises a plurality of switch element groups, and each of the switch element groups is coupled between a first voltage and a second voltage and controlled by a plurality of control signals.

10. The multi-phase LLC resonant converter according to claim 9, wherein when drain source voltage signals of the switch elements in the switch element groups are less than a reference voltage, the control signals turn on the switch elements in the switch element groups.

11. The multi-phase LLC resonant converter according to claim 1,
wherein magnetic cores of the resonant inductors and a magnetic core of the transformer are integrated to form an integrated magnetic core structure, and the integrated magnetic core structure comprises a first cover plate, a second cover plate, and an intermediate laminated board, and
wherein a first core column, a second core column, and a third core column of the resonant inductors are located between the first cover plate and the intermediate laminated board, and a first core column, a second core column, and a third core column of the transformer are located between the intermediate laminated board and the second cover plate.

12. The multi-phase LLC resonant converter according to claim 11, wherein an air gap exists in each of the first core column, the second core column, and the third core column of the resonant inductors.

13. The multi-phase LLC resonant converter according to claim 12, wherein the air gap in the second core column is smaller than the air gap in the first core column and the air gap in the third core column.

14. The multi-phase LLC resonant converter according to claim 12, wherein the air gap in the first core column is equal to the air gap in the third core column.

15. The multi-phase LLC resonant converter according to claim 12, wherein the air gap exists in a middle portion of each of the first core column, the second core column, and the third core column.

16. The multi-phase LLC resonant converter according to claim 11, wherein the first core column, the second core column, and the third core column of the resonant inductors are not coupled to one another.

17. The multi-phase LLC resonant converter according to claim 11, wherein coils on the first core column, the second core column, and the third core column of the resonant inductors are wound in a same direction.

18. The multi-phase LLC resonant converter according to claim 11, wherein an air gap exists in each of the first core column, the second core column, and the third core column of the transformer.

19. The multi-phase LLC resonant converter according to claim 18, wherein the air gap in the second core column is smaller than the air gap in the first core column and the air gap in the third core column.

20. The multi-phase LLC resonant converter according to claim 18, wherein the air gap in the first core column is equal to the air gap in the third core column.

21. The multi-phase LLC resonant converter according to claim 18, wherein the air gap exists in a middle portion of each of the first core column, the second core column, and the third core column.

22. The multi-phase LLC resonant converter according to claim 11, wherein the first core column, the second core column, and the third core column of the transformer are not coupled to one another.

23. The multi-phase LLC resonant converter according to claim 11, wherein primary side coils and secondary side coils on the first core column, the second core column, and the third core column of the transformer are wound in a same direction.

24. The multi-phase LLC resonant converter according to claim 11, wherein primary side coils and secondary side coils on the first core column, the second core column, and the third core column of the transformer are wound symmetrically with respect to a reference axis.

25. The multi-phase LLC resonant converter according to claim 11, wherein primary side coils and secondary side coils on the first core column, the second core column, and the third core column of the transformer are wound in an interleaved manner.

26. The multi-phase LLC resonant converter according to claim 11, wherein coils on the first core column, the second core column, and the third core column of the resonant inductors are wound in a same direction as primary side coils and secondary side coils on the first core column, the second core column, and the third core column of the transformer.

27. The multi-phase LLC resonant converter according to claim 11, wherein air gaps in the first core column, the second core column, and the third core column of the resonant inductors are larger than air gaps in the first core column, the second core column, and the third core column of the transformer.
